(19) United States
(12) Patent Application Publication
(10) Pub. No.: US 2016/0083236 A1
(43) Pub. Date: Mar. 24, 2016

(54) Holder for a Container Receptacle and Container Receptacle

(71) Applicant: George Robert COLLINS, Schwalbach am Taunus (DE)

(72) Inventor: George Robert Collins, Schwalbach am Taunus (DE)

(21) Appl. No.: 14/777,752

(22) PCT Filed: Mar. 20, 2014
(86) PCT No.: PCT/DE2014/100094

§ 371 Date: Sep. 17, 2015

(30) Foreign Application Priority Data
Mar. 26, 2013 (DE) 10 2013 103 111.0

(51) Int. Cl. B67B 6/00

(52) U.S. Cl. CPC B67B 6/00

(57) ABSTRACT

A holder (10) for a container receptacle (100), which is provided for receiving containers (B), wherein each container (B) has a container opening (B1) with an opening rim (B2), a container wall (B3) and a container base (B4), has a first section (20) which is non-rotatably mounted on or in the container receptacle (100), a second section (30), which is rotatably mounted on the first section (20) about the longitudinal axis (A), a sealing surface (52), which is provided to seal the container opening of a container (B) inserted into the container receptacle (100), and a pressure line (60) which passes through the first section (20) and the second section (30) and opens out through the sealing surface (52), wherein the second section (30) is rotatably mounted around the pressure line (60). The second section (30) mounted rotatably at the first section (20) which can be displaced along the longitudinal axis (A) relative to the first section (20) by a lift degree (Z), wherein the second section (30) actuates via a valve actuator (80) a valve (70) which is coupled to a valve actuator (80). (FIG. 1)

### CROSS-REFERENCE TO RELATED APPLICATIONS

This application is the U.S. national stage of International Application No. PCT/DE2014/100094 filed on Mar. 20, 2014, and claims the benefit thereof. This application also claims the benefit under 35 USC 119 of German Application No. 102013103111.0 filed on Mar. 26, 2013; all applications are incorporated by reference herein in their entirety.

### BACKGROUND

The invention relates to a holder for a container receptacle according to claim 1 and a container receptacle according to claim 15.

For handling containers, such as bottles, cans, bottles, etc., which are filled through a filling hole with flowable, pasty or solid products (before or subsequently) are provided on one section of a container wall with a tag or a print and the different contain receptacles and holders are known to position the container during the filling and/or for tagging or printing in a preset orientation and to centre them relative to a preset axis, most often the container axis.

For example, screen printing or pad printing method can be used for printing on the containers. However, using them does not enable to fill the PET containers, especially with empty PET bottles, and causes regular deformations of the printing surface, whereby the print image is often of poor quality.

In addition to the screen and pad method often electrostatic print heads are used, which operate according to the ink jet printing or tone jet principle. A particular problem here, however, is that during the printing operation a portion of the printing ink to be printed does not reach the region of the container outer surface, but is sprayed into the surrounding air. Thus an aerosol of finely divided ink or printing ink particles can be used, which are usually transported at relatively high speed and additionally swirled and distributed for printing on containers rotating around their own axis.

Thus, complex measures must be taken to prevent contaminants from entering the containers as well as their environment. This is especially true if hygienic rules are observed in accordance with the product to be filled, such as in the food, cosmetic or medical field.

DE 10 2009 013 477 A1 therefore proposes for a printing device a container receptacle in which is clamped rotatably the bottle to be printed between a bottle plate and a holder in the form of an axially movable die. Each container receptacle is also surrounded during printing operation by a protective sleeve, which is provided for sucking printing ink sprayed with a suction device. A rod-shaped electrode is provided additionally within the protective sleeve and the direction of rotation before the print head, an electrode which is acted upon with an increased DC voltage to selectively direct the printing ink to the surface to be printed and to counteract the emergence of colour fogs.

In a device disclosed in DE 10 2006 001 223 A1 for printing on bottles or other containers, each bottle for controlled rotation during printing operation is kept with its bottle mouth in a clamping notch which is driven peripherally by a drive coaxially to a printing station with the bottle axis. The bottle lies with its bottom during printing operation against a turntable-like support element. The respective bottle must be accurately positioned and centred by the clamping notch and supporting element formed as holders. To adjust the print head with respect to the surface of the bottle to be printed with the smallest possible distance, additional adjustment or spacer elements are provided in the form of rollers, with which the printhead is supported on the bottle outside the surface to be printed. To further improve the printed image and to bring the printing ink targeted on the bottles, a corona element is provided on the printing device, with which the outer surface of the bottle is electrostatically charged. It is also possible to pressurise the bottle before printing on the bottle mouth with a deionised or electrically charged gaseous medium, such as deionised or electrically charged air, to reach also electrostatic charging of the bottle improving the printing quality.

A major disadvantage of these known container receptacles lies in that the printing is of PET containers not yet filled is problematic because they rapidly deform when aligning and centring within the container receptacles, particularly when clamping between the holders. In particular, it may cause considerable deformations during the damping of relatively thin-walled containers in the container receptacle, not only of the printing surface but of the entire container, whereby the print image is deteriorated to a vast extent or even a printing becomes impossible. Thin-walled PET bottles show even when empty already form inaccuracies, which may interfere with the print image.

Another disadvantage is that during the printing process impurities, in particular ink residues or ink mist, cannot be reliably prevented from entering the inside section which has not been not filled yet and therefore containers which have not been sealed yet. However, re-cleaning and disinfecting the containers leads to increased costs, which is particularly undesirable in modern printing and filling stations.

### SUMMARY

A holder (10) for a container receptacle (100), which is provided for receiving containers (B), wherein each container (B) has a container opening (B1) with an opening rim (B2), a container wall (B3) and a container base (B4), has a first section (20) which is non-rotatably mounted on or in the container receptacle (100), a second section (30), which is rotatably mounted on the first section (20) about the longitudinal axis (A), a sealing surface (52), which is provided to seal the container opening of a container (B) inserted into the container receptacle (100), and a pressure line (60) which passes through the first section (20) and the second section (30) and opens out through the sealing surface (52), wherein the second section (30) is rotatably mounted around the pressure line (60). The second section (30) mounted rotatably at the first section (20) which can be displaced along the longitudinal axis (A) relative to the first section (20) by a lift degree (Z), wherein the second section (30) actuates via a valve actuator (80) a valve (70) which is coupled to a valve actuator (80).

### DETAILED DESCRIPTION

The aim of the invention is therefore to overcome these and other disadvantages of the prior art and to provide a holder for a container receptacle, which makes it possible to receive a container quickly and precisely in the container receptacle and to prevent efficiently any deformation of the container both during the clamping process and during the printing process. The holder should also be built economically with simple means and assist the centring of the container in the container receptacle. The aim is also to ensure as low as possible friction rotation of the container within the container receptacle. Any contamination moreover of the container volume should also be prevented, i.e. no impurities should enter the container.

The main features of the invention are given in claim 1 and in claim 15. Embodiments are subject matter of claims 2 to 14.

A holder for a container receptacle which is provided for receiving containers, wherein each container has a container opening with an opening rim, a container wall and a container base, includes according to the invention
a first section which is non-rotatably mounted on or in the container receptacle,
a second section, which is mounted on the first section so as to be rotatable about a longitudinal axis, and a sealing surface, which is provided to seal the container opening of a container inserted into the container receptacle, and
a pressure line, which passes through the first section and the second section and opens out through the sealing surface.

Such a holder enables to provide a container used in the container receptacle—as soon as it comes in contact with the opening edge of its container opening on the sealing surface of the second section for abutment—to act upon via the pressure line with an internal pressure, whereby the container is stabilised and formed from the inside. Consequently, the container can be no longer deformed during clamping between the holder and a counter-holder within the container receptacle or even crushed. Moreover, printing processes can now be used which load the container from the outside thereof with a force such as pad printing, screen printing or laser printing process even with relatively thin-walled containers. The internal pressure built up through the pressure line in the container always acts as a counter force and always prevents any deformation of the container reliably.

Moreover form inaccuracies can be reduced by the internal pressure of elastic or thin-walled containers, particularly if they are rotationally symmetrical containers such as bottles or cans. Enhanced print quality can be achieved even in contactless printing processes. This concerns in particular an automatic, computer-controlled high-speed HD colour printing of PET bottles and similar hollow bodies by contactless direct printing.

Due to the rotatable mounting of the second section of the holder in its first section, the container used in the container receptacle can be received or supported rotatably and driven, which allows for example the use of various printing processes. The container is for this purpose preferably aligned with its container axis coaxial to the longitudinal axis of the first section of the holder, with the container opening facing the holder with its opening edge and thereby pressed against the sealing surface of the second section.

The holder according to the invention acts not only as a clamping or fixing means within the container receptacle, but primarily as a rotary transmission, which enables reliable and precise reception of empty unfilled, thin-walled PET containers, some of which already have a wall thickness of only 0.1 mm. By the inner pressure, which may build up on the pressure line in the container, the entire container is stabilised in itself so that it by holding it in the container receptacle for example between a (counter) holder receiving the container bottom, and the holder according to the invention—said container is not deformed or even crushed any longer. The container is stably stored for subsequent processes.

The sealing surface formed on the second rotating section of the holder, which is provided for sealing the container opening, prevents on the one hand the medium introduced via the pressure line into the container from escaping too quickly. On the other hand no impurities or coloured particles can penetrate into the container at least during the printing process. For this purpose, the increased internal pressure built up in the container also contributes, i.e. even if the container opening with its opening edge should not hang freely and completely sealed on the sealing surface, to prevent the penetration of contamination from outside into the container.

Another advantage of the invention is the possible retrofitting of existing container receptacles with a holder according to the invention. Existing reception devices can therefore receive soft/elastic containers by retrofitting in addition to solid, form-stable containers, without the latter being damaged or deformed. Thus, there is an affordable way to extend the field of application of existing container receptacles.

Structurally, the pressure line is advantageously at least partially coaxial with the longitudinal axis, wherein the second section of the holder is preferably rotatably supported about the pressure pipe. Thereby, it is possible to form the pressure pipe as part of a rotation axis, in particular no rotation within the pressure line coupling is necessary, which keeps the production costs very low for the holder according to the invention. Instead, a rotary seal is provided preferably between the second section and the pressure line, which for example is designed as a tube. Consequently, the pressure line and the bottle opening uptake can be sealed in a cost-efficiently and maintenance-friendly way.

The pressure line preferably emerges into an outlet, whereas said is arranged concentrically to the longitudinal axis. Thus, the medium supplied to the container by the line pressure is always filled centrically to the longitudinal axis into the container which may also be provided with smaller filling openings.

An important aspect of the invention provides that the sealing surface of the second section is formed on a front side of the second section facing away from the first section, i.e. that the sealing surface is preferably perpendicular to the longitudinal axis and faces the container opening. Thus, the container can be pushed along the longitudinal axis of the holder in the direction of the longitudinal axis against the second section and thus against the sealing surface whereby generating a tight connection.

The invention further provides that the sealing surface is concave relative to the front face of the second section. The sealing surface at the same time forms a centring device for the container that is always aligned centrally to the longitudinal axis or to the axis of rotation. With such a centring device the container can be positioned in a printer device always at the right distance with respect to a colouring printer unit. In addition, the container with its container axis can be oriented on the longitudinal axis of the holder so that upon rotation, the parts can rotate perfectly and the distance to the printer unit is consistent.

It is advantageous in terms of manufacturing technology if the sealing surface is formed concentrically with respect to the longitudinal axis of a conical surface or a frustoconical surface. This, too, has the advantage that when merging holder and holder, the container is oriented radially relative to the longitudinal axis and relative to the container opening, when clamping the container in the container receptacle. The concave or conical sealing surface and oriented towards the container opening also has the advantage that neither the sealing effect nor any other component of the retainer protrudes into the container opening and thus into the container, which is especially important with sterile containers for the food, cosmetics and medicine industries.

In order both to achieve optimal sealing effect as well as optimum adhesive friction between the opening edge of the container opening and the sealing surface, the latter is provided with a coating. This makes it possible to drive a container already rotating by holding it in the container receptacle on the holder according to the invention, until the opening edge of the container opening comes to rest on the sealing surface. The opening edge engages the sealing surface and due to the existing static friction increases the second section of the holder so that the second section rotates relative to the first section clamped together with the container.

In a further embodiment of the invention, the sealing surface is formed on a sealing element which is detachably inserted into the second section, the second section being provided for this purpose with a corresponding recess for the sealing element. This makes it quickly and easily possible to adapt the sealing surface of the holder to each container to be received therein and its container opening. Thus, differently shaped and/or inclined surfaces can be used for example for different types of containers. In addition, adhesion friction jumps are avoided during sliding into the centring position. The detachable arrangement of the sealing element allows quick and easy replacement thereof in case of defect.

Another important embodiment of the invention provides that the second section is mounted rotatably at the first section along the longitudinal axis relative to the first section which can be displaced by a lift degree. This lift degree, for example, can serve to initiate switching operations, for actuation switching elements or for opening and closing a valve in the discharge line. A further advantage of the lift amount is that this dampens or cushions the placement of the container on the second section thereby further reducing the risk of deformation of the container.

Without contact with the container, the lift degree is preferably stretched, i.e. the second section is positioned at a defined distance from the first section. If the container on the other hand rests on the sealing surface, and it is still pressed a little more against the holder, the lift degree is compressed until, for example, the second section abuts the first section or until a stop blocks the movement of the second section. With a hanging positioning of the holder, gravity can be sufficient to bring the second section in its spaced position with respect to the first section. Alternatively or additionally, a spring element can be inserted between the first section and the second section of the holder. It proves particularly favourable in practice to provide a lift amount of at least 2 mm and maximum of 7 mm.

In order to keep the friction between the first section and the second section small during rotation of the container in the container receptacle, the invention further provides that a ball bearing is provided between the first section and the second section.

Preferably, the ball bearing is designed cageless. It thus enables both the rotational and the lifting movement between the first section and the second section of the holder. Furthermore, the ball bearing should be running continuously dry particularly in the food sector so that no lubricants enter nor touch the container. Another advantage is a dry-running ball bearing when using bearing parts made of glass materials and/or composite materials.

Overall, in the embodiment of the holder according to the invention, the rotational movement of a container about its longitudinal axis when placing the container opening dose is transmitted to the sealing surface of the second section via the sealing surface with a defined static friction to the second section, which can rotate frictionless relative to the first section, which is non-rotatably damped in the container receptacle. The second section therefore rotates with the container, while the first section forms the axis of rotation together with the pressure line. The wear is extremely low and the concave sealing surface always provides a tight seal with the container opening and centres simultaneously the container in the container receptacle.

The holder thus forms a rotary transmission with the pressure line, which allows a relatively sensitive thin-walled containers, e.g. from PET, to be fixed in the receiving container, without the container being deformed or even destroyed because even before the container is completely damped, the required stabilising pressure is established via the pressure line in the container.

To realise the rotational mounting of the second section on the first section of the holder with a lift degree, a further development of the invention provides that the first section is provided with a shank at its end facing the second section wherein a running surface is formed for the balls of the ball bearing on the outer circumference of the shank at least in sections. The shank carries at its end facing the second section also an attachment or insert, which prolongs the shank and the running surface with its outer circumference. The latter is formed concave and radially with respect to the longitudinal axis, i.e. it forms a raceway for the balls of the ball bearing, with a cylindrical middle section, a first side section facing the first section and a second side section facing the second section. To do so, the side sections of the running surface are oppositely set at an angle oblique to the longitudinal axis, i.e. the side sections form conical surfaces which provide stop surfaces for the balls of the ball bearing in the longitudinal direction of the longitudinal axis.

Consequently, the balls of the ball bearing can on the one hand roll with a rotation of the second section relative to the first section in the circumferential direction on the running surface, which ensures frictionless pivot bearing. At the same time, the balls can move in the direction along the longitudinal axis of the cylindrical central section of the running surface, allowing a linear movement between the second section and the first section in the axial direction. In that case, the balls meet a stop at the first and second side sections of the running surface respectively, i.e. the lift degree between the first section and the second section of the holder is determined by the axial height of the cylindrical running surface and the distance between the side sections.

A further embodiment of the invention provides that the pressure line includes a valve which is coupled to a valve actuator. Such a valve allows precise control of the supply of a medium to be supplied through the pressure line to the container. In particular, it is possible to stop the volume flow rate if no bottle is in contact with the second section of the holder. On the other hand, a container with its opening edge comes in contact with the sealing surface of the second section and the valve can be opened via the valve actuator. For this purpose, it is provided that the valve actuator can be actuated by the second section, which is longitudinally and displaceably mounted on the first section, wherein the valve actuator can be mechanically or electrically coupled to the valve. For example, the valve actuator can be a stylus running substantially parallel to the longitudinal axis. This may have at its tip a rotatable ball. The stylus slides oppositely via a circular track, which is formed on the second section. In order to reduce friction and increase the service life, it is advisable to construct the circular track by a sliding ring, which may be formed of a material having a low coefficient of friction and low wear. For maintenance purposes, the ring should also be interchangeably attached to or in the second section.

In a specific embodiment, the valve actuator is sensitive to compressive force, i.e. it opens above a certain defined and adjustable force, which acts on the valve actuator, the valve, so as to ensure that the valve opens in the pressure line, as soon as the container is loaded during clamping with the defined or preset force. If the valve opens during the linear movement of the second section, the container is filled with the pressure medium and stabilised from within so that the bottle will not be deformed nor even crushed during the further clamping operation. Other or additional sensing devices, such as for example optical devices or sensors, are not necessary to trigger the valve actuator. The valve actuator is preferably sensitive to compressive force along the longitudinal axis. Thus, the lift degree and the attachment of the holder on the bottle opening for triggering the valve can be used. The preset triggering force enables to determine the trigger time accurately so that even extremely thin-walled containers can be inserted into the container receptacle. The trigger time is independent of the type of container and does not need to be readjusted when changing containers

The possibility to open the valve in the discharge line immediately after the contact of the container with the sealing surface of the first section of the holder via the valve actuator even before the second section has reached its final position at the end of the lift amount with respect to the first section is particularly advantageous. This ensures that the full pressure is generated in the container before the container within the container receptacle has reached its end position and hence its clamping position. To do so the valve actuator is coupled to the lift degree. This is possible especially by the arrangement of the valve actuator between the first section and the second section of the holder. In addition to the triggering force, the trigger path can thus also be specified in order to reliably prevent the container from being deformed or crushed when clamping the holder according to the invention.

Further advantages are provided if the valve and the pressure line form a preassembled unit. This not only simplifies the production and the assembly of the holder, it simplifies especially the repair and the maintenance operations because wear components can be replaced quickly and easily. This also applies when the valve actuator is part of the assembly.

A container receptacle according to the invention for receiving containers, wherein each container has a container opening with an opening rim, a container wall and a container base, includes
a holder (for holding the container base of a container inserted into the container receptacle, said holder being rotatably mounted about a longitudinal axis, and
a holder according to one of the claims 1 to 14,
wherein the second section of the holder is rotatably mounted on the first section about the longitudinal axis, and
wherein the distance is variable between the holder and the holder by a tensioning means.

With such a container receptacle, e.g. which is used in a printing device, the container support can be acted upon during printing with an internal pressure so that in particular empty and unfilled PET containers cannot be deformed during damping between the holder and a counter-holder. At the same time it is ensured that no contaminants enter the container during the handling and/or printing process so that even sterile containers can be handled or processed. By pressurisation also, shape inaccuracies are reduced by elastic containers with a favourable effect on the printed image. Thus, the container receptacle is particularly suitable for the absorption of light PET bottles.

Depending on the configuration of the holder, the other advantages described above can be provided by the respective configuration with the container receptacle.

### BRIEF DESCRIPTION OF THE DRAWINGS

Further features, details and advantages of the invention will become apparent from the wording of the claims and from the following description of embodiments with reference to the drawings. The figures are as follows:

FIG. 1 is a diagonal view of a holder according to the invention, partly in section;

FIG. 2 is a sectional view of another embodiment of a holder according to the invention; and

FIG. 3 is a schematic representation of a receiving container with a holder according to the invention.

### DETAILED DESCRIPTION OF THE PREFERRED EMBODIMENTS

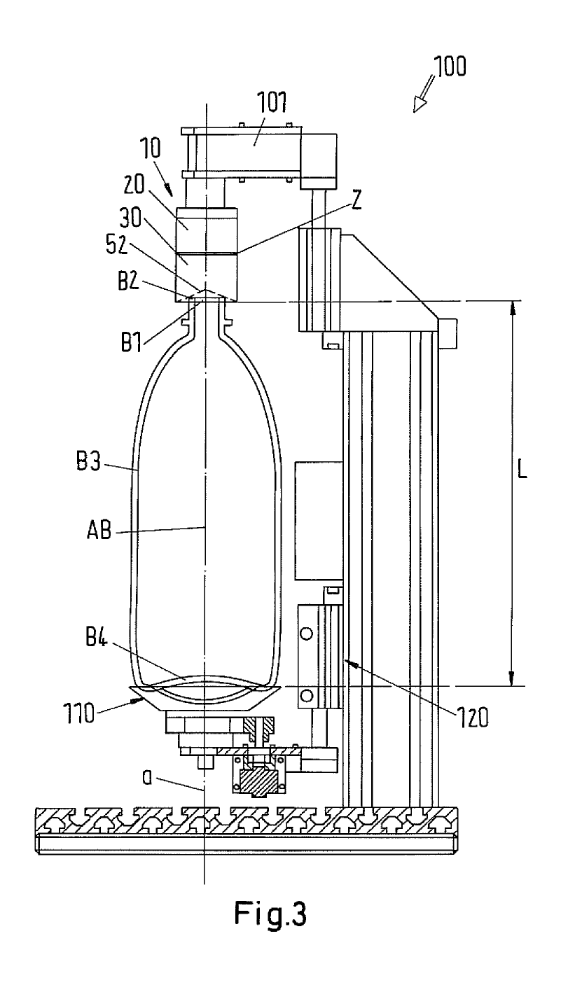

The holder generally designated in Figure with 10 is used for fastening and fixing a container B in a container receptacle 100, as is shown for example schematically in FIG. 3. The container receptacle 100 is used for receiving and handling a container B, for example a bottle, a can, a cup, a bottle, etc., which should be filled by a container opening 81 through with a flowable, pasty or solid product. Before filling the tank B this is provided with a print on a (unspecified) section of its container wall B3. For this purpose, several of the container receptacles 100 are placed in a (not further described) printing device, which apply print images with corresponding printheads to the container walls B3 of the container B.

For the printing process, it is usually necessary that the vessel B rotates about its own axis AB. For this purpose, the container B stands with its container bottom B4 on a lower holder 110, which can receive the container bottom B4 with a force, fit and/or frictional engagement. The holder 110 is motor-driven about a rotation axis a. It is moreover a mounted adjustably by means of a clamping device 120 along the axis of rotation a, so that the distance L between the lower holder 110 and the holder 10 arranged thereabove can be changed, in particular for damping the container B between the holders 10, 110. For receiving and defining the upper holder 10, the container receptacle 100 has a receptacle 101.

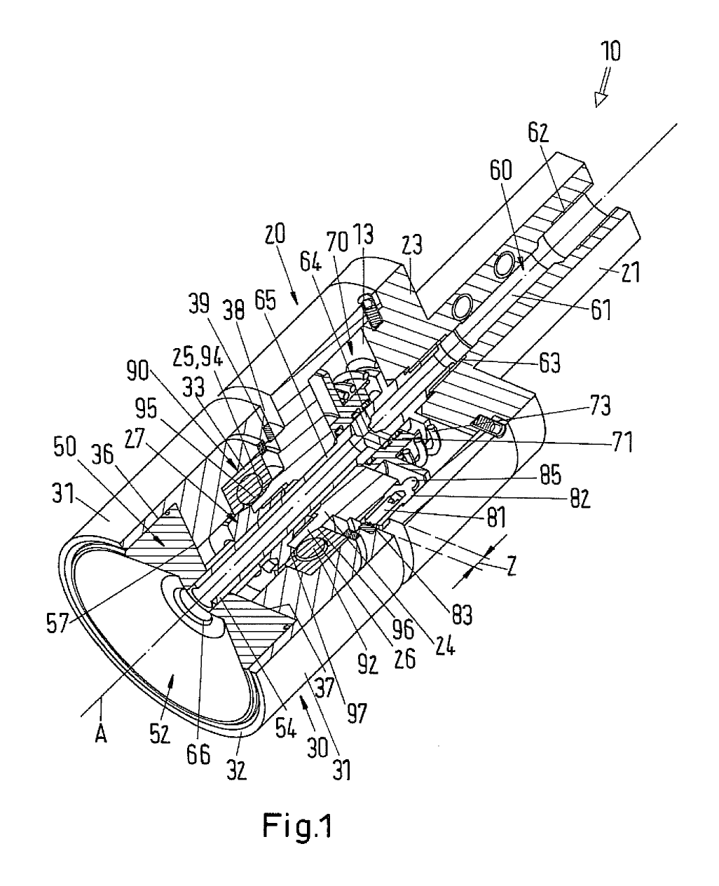

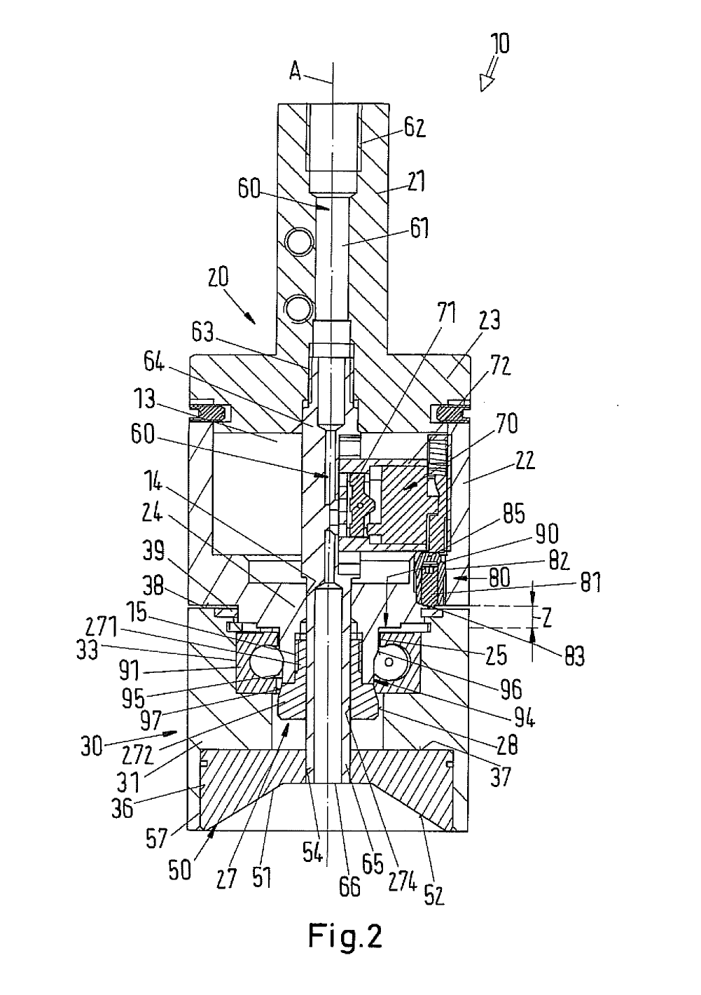

The holder 10 has—as shown by FIG. 1 and FIG. 2—a first section 20 which is rotatably connected to a shank 21 in the receptacle 101 of the container receptacle 100. The receptacle 101 is for this purpose provided with suitable (not shown) damping devices. An anti-twist device (also not shown) ensures that the first section 20 of the holder 10 cannot rotate relative to the container receptacle 100.

The first section 20 is basically cylindrical. It has a cylindrical housing 22 which forms a receiving space 13 and at its end facing the receiving end 101 is provided with a lid 23. The shank 21 is formed on the lid 22. The housing 22, the cover 23 and the shank 21 are formed substantially coaxially to a longitudinal axis A, which lies concentrically to the axis of rotation A when the holder 10 is mounted with its shank 21 in the receptacle 101.

The housing 21 at its end facing away from the receptacle 101 and the shank 21 turns into in a second shank 24 on which is also formed coaxially with respect to the longitudinal axis A. The shank 24 has a cylindrical outer periphery 25 and a cylindrical through-hole 14 which is provided at the end with an internal thread 15. An attachment from the bottom 27 is inserted in the shank 24, whose shank 271 is provided with a corresponding external thread (not illustrated more in detail). The shank 271 carries a head 272, which prolongs with its outer circumference 28 the outer periphery 25 of the shank 24. The attachment 27 is likewise provided with a cylindrical through-hole 274, which prolongs the through-hole 14 of the shank 24 with the same diameter.

It can be seen in FIGS. 1 and 2, that the outer periphery 25 of the shank 24 and the outer periphery 28 of the attachment 27 together form a circumferential surface 94 which has a cylindrical central section 95, a first section 96 facing the first side section 20 and a second side section 97 oppositely configured, wherein the outer diameter of the central section 95 is smaller than the outer diameter of the outer peripheries 25 and 28, and wherein the side sections 96, 97 are formed in a substantially planar and obliquely in an angle (not illustrated more in detail) relative to the central section 95. In this manner, a substantially concave surface contour is obtained in the axial direction which is cylindrical in the middle and conical at the end. As shown in FIG. 2 in more detail, the first conical side section 96 and the intermediate cylindrical section 95 are formed on the shank 24, while the second conical side section 97 is formed on the attachment 27. The cylindrical central section 95 ends consequently at the transition from the shank 24 to the attachment 27, which is connected via the thread 15 detachably to the shank 27.

A second section 30, which is rotatably mounted on the first section 20, is also substantially cylindrical. It has a cylindrical housing 31 which is provided at its region facing the first section 20 with a ball bearing 90. This has a cylindrical ring 91 which is fixedly inserted into a first receptacle 33 in the housing 31. Balls 92 are mounted in a captive ring channel (not illustrated more in detail) in the ring 91. The ball bearing 90 is thus formed cageless, whereas the ring 91 and the balls 92 are made of a composite material. It is non-magnetic, FDA compliant, maintenance-free and can be operated without lubricants.

As shown particularly in FIG. 2 in more detail, the second section 30 of the holder 10 is fitted onto the shank 24 of the first section 20, preferably placed, wherein the axial height of the ball bearing 90 is set within the housing 31 such that the balls 92 of the ball bearing 90 rest with slight play for movement on the central section 95 of the peripheral surface 94. The balls 92 can therefore roll in the circumferential direction on the circumferential surface 94, while the second section 30 rotates relative to the first section about the longitudinal axis A, i.e. the peripheral surface 94 forms a running surface for the balls 92 of the ball bearing 90. At the same time the balls 92 can move on the cylindrical middle part 95 of the running surface 94 but also in the direction of the longitudinal axis A, i.e. the second section 30 can rotate not only relative to the first section 20, it can also perform a linear movement along the longitudinal axis A, in particular between two end positions.

The balls 92 do not only lie at the centre section 95 of the running surface 94, i.e. a first end position of the second section 30 (see FIG. 2). They abut in the direction of the longitudinal axis A also on the first side section 96 of the running surface 94. Because the side section 96 follows an angle relative to the longitudinal axis A, the balls cannot move 92 further upward. The essentially conical side section 96 thus forms a first stop for the balls 92 and thus forms a stop for the movement of the second section 30 in the direction of the first section 20. If the balls 92 of the ball bearing 90 are at the first stop, the lift degree Z is almost used up and the second section 30 is located opposite the first section 20 in a first axial position.

The balls 92 lie at the centre section 95 of the running surface 94 as well as on the second section 97 of the running surface 94, in a second end position of the second section 30 (see FIG. 1). Because said section 97 follows an angle relative to the longitudinal axis A, the balls 92 cannot move further downward. The essentially conical side section 97 thus forms a second stop for the balls 92, and thus a stop for the movement of the second section 30 in the opposite direction. The second section 30 of the holder 10 is now in a given lift degree Z of the maximum distance Z with respect to the first section, and therefore in a second axial position.

To do so, the second section 30 is rotatably mounted at the first section 20 along the longitudinal axis A relative to the first section 20—independently of the rotary motion—between the first and second axial position slidably supported by the lift degree Z, whereas the axial length of the lift amount Z of the axial height of the central section 95 of the running surface 94 is therefore specified and consequently by the axial distance between the side sections 96 and 97.

The second section 30, at its end opposite the ball bearing 90, is provided with a second receptacle 36 which is open towards the front face 32 of the housing 31. In the receptacle 36, a sealing member 50 is frontally inserted coaxially to the longitudinal axis A, substantially cylindrical and provided with a central through-opening 54. The latter has the same inner diameter as the through-openings 14 and 274 of the shank 24 and of the attachment 27.

The back 57 of the sealing element 50 rests flat on the floor 37 of the receptacle 36, while the opposite front side 51 forms a sealing surface 52, which is provided for sealing the container opening B1 of the container B inserted into the container receptacle 100. The sealing surface 52 is substantially concave, in particular as a truncated cone in cross-section. It has a circular central part (not illustrated more in detail) lying concentrically to the longitudinal axis A and a conical edge section (also not illustrated more in detail).

The sealing element 50 is releasably inserted by fixing means (not shown) in the receptacle 36, so that it can at any time be replaced with another sealing means 50. Each sealing means 50 has therefore with respect to the recess 36 always the same dimensions. The diameter of the middle section and the dimensions of the edge section of the sealing surface 52 on the other hand can vary from one sealant to another sealant in order to use containers B having different dimensions in the container receptacle 100, in particular container B, with differently sized container openings B1 with different diameter aperture edges B2.

The conical configuration of the sealing surface 52 which is formed on the front face 32 of the second section 30 facing away from the first section 20, has the advantage that the containers B after insertion in the lower bracket 110 of the container receptacle 100, and after setting the opening edge B2 on the sealing surface 52 by activation of the clamping means 120 is automatically centred with respect to the longitudinal axis A and the axis of rotation a, so that the container axis AB is always oriented concentrically with respect to the longitudinal axis A and the axis of rotation A and that the container B can also be rotated at a high speed almost free from unbalances.

The holder 10 for the container receptacle 100 has moreover a pressure line 60 which passes through the first section 20 and the second section 30 and opens out through the sealing surface 52. A preferably gaseous medium is passed via the pressure line 60, for example, compressed air, preferably sterile compressed air. Therefore, there is a container B with its container opening B1 coaxial to the longitudinal axis A on the sealing surface 52 of the holder 10, the container can be filled with the gaseous medium, whereas a defined pressure can be built in the container B so that the container B is stabilised from within.

The pressure line 60 is formed within the first section 20 substantially of a through hole 61, which begins in the upper shank 21 and ends in the lid 23. An internal thread 62, 63 is formed at each end. The internal thread 62 provided at the upper end of the shank 21 is used for connecting a pressure line, through which the gaseous medium is supplied to the holder 10 and the pressure line 60, respectively. The internal thread 63 formed in the lid 23 supports a pipe section 64, which is provided with a matching external thread (not illustrated more in detail). This pipe piece 64 extends through the receiving space 13 in the housing 22 and merges at its end facing away from the second section 20 in a tube section 65 traversed by the through-hole 14 in the shank 24, the through-hole 274 in the attachment 27 and the through-hole 54 in the sealing element 52 with slight play for movement. The pipe section 66 leads into an outlet opening 66 which is concentric with the sealing surface 52. Thus, the second section 30 is rotatably supported coaxially with respect to the longitudinal axis A and an extending pressure line 60 to the axis of rotation a.

A valve 70 (not described more in detail) is formed between the through-hole 61 and the pipe section 66, which is coupled to a valve actuator 80.

The valve 70 is preferably a mechanical valve with a movable valve member 71, which in a first position, namely the dosed position, interrupts the flow of the gaseous medium through the pressure line 60, and in a second position, namely the open position, allows the flow of the medium by the pressure line 60.

The valve member 71 can be configured for example as a side member which is slidably mounted along the longitudinal axis A of the tubular piece 64. The valve element 71 can also be designed as a membrane element or as a tilting element which are mounted movably in a valve housing 72, respectively. Each valve member 71 is held by a defined force in the closed position. This defined force can be generated for example by a spring element 73, which loads the valve element 71 directly. One can also produce the force, with which medium is guided in the pressure line, inasmuch as the latter is passed through a bypass (not shown more in detail) on the valve element 71. If the valve member is 71 in its closed position, the second section 30 of the holder is located relative to the first holder 20 in its second axial position.

The valve actuator 80 is a stylus 81 arranged in the housing 22 of the first section 20, which is mounted parallel to the longitudinal axis A of the holder 10 to be longitudinally displaceable in a recess 82.

The stylus 81 has a first end 83 facing the second section 30 of the holder 10. It can therefore lie permanently on the front face 38 of the housing 31 whereas the end 83 slides over the front face 38 when the second section rotates relative to the first section 20. In order to keep the friction between the stylus 81 and the housing 31 as low as possible, the stylus 81 is rounded at its end 83. However, it can also be provided with a ball (not illustrated) which is formed at the end in the stylus 81, wherein the ball upon rotation of the second section 30 rolls on the front face 38. To increase the wear resistance, a slide ring 39 can be inserted into the front face 38 on which the stylus 81 slides. The slide ring 39 can also further reduce the friction between the stylus 81 and the housing 31. The stylus 81 further has an end 85 facing the second section 20 which is in operative connection with the valve element 71. This operative connection is designed such that upon actuation of the stylus 81 in the direction of the shank 21, the valve element 71 is brought from the closed position to the open position. This can also be done with power assistance on demand, for example by a suitable lever mechanism or a spring element It is also conceivable to use the pressure of the medium guided through the pressure line inasmuch as the latter is passed through a bypass (likewise not shown) to the valve element 71. If the valve member is 71 in its open position, the second section 30 of the holder is located relative to the first holder 20 in its first axial position.

It will be appreciated that the stylus 81 can be actuated, can be opened in particular and with this, the valve 70 via the rotatably mounted second section 30 of the holder 10. As soon as the second section 30 is moved along the longitudinal axis A to the first section 20 of the holder 10, the stylus 81 resting on the permanent housing 31 is moved along the longitudinal axis A and pushed into the housing 22. To do so, the valve 70 is opened via the operative connection between the stylus 81 and the valve element 71, and the medium guided in the pressure line 60 can flow out of the outlet opening 66.

The force acting on the valve element 71 and/or the length of the stylus 81 enables to define accurately at which position and at which time the valve 70 opens when the rotating second section 30 is moved axially to the first section 20. In order to change the length of the stylus 81, this is preferably formed in two parts, wherein the two parts (not illustrated more in detail) of the stylus 81 can be guided telescopically into each other, preferably via a thread. The definable force acting on the valve element 71 enables the stylus 81 to be sensitive to compressive force.

A container B is inserted into the container receptacle 100 shown in FIG. 3 and the two holders 10, 110 moved are towards one another to damp the container between the holders 10, 110, the container B comes to abut with its container opening B1 to the sealing surface 52. The shaping of the container B is centred initially automatically with respect to the longitudinal axis A of the holder. At the same time, the second section 30 of the holder 10 supports the rotational movement of the container B without loading these axially. Now the rotating container B pushes the co-rotating second section 30 of the holder 10 along the longitudinal axis A to the first section 20, the valve actuator 80 is actuated by the second section, which in turn opens the valve 70 upon reaching a defined contact pressure on the part of the container and/or after traveling a defined path along the lift amount Z. From now on, the medium guided in the pressure line 60 flows into the vessel B, whereby the latter is stabilised from within. The container B can now be fully clamped between the holders 10, 110, until the second section 30 reaches its first axial position with respect to the first section in which the lift degree Z is nearly depleted.

As shown in FIGS. 1 and 2, the tube piece 64 and the tubular section 65 are formed preferably integrally. Even the valve 70 may be fixedly connected with the tube piece 64 so that the valve 70 and the pressure line 60 form a preassembled constructional unit. Thus, the assembly of the holder 10 according to the invention is particularly simple.

The invention is not limited to the embodiments described above, but can be modified in many ways. So the first section 20 can be fixed directly into the receptacle 101 instead on the shank 21. Further, the sealing surface 52 may be provided if necessary with a coating. The sealing surface 52 may also protrude over the housing 31 radially, depending on the size of the container B.

It can be seen that a holder 10 for a container receptacle 100 which is provided for receiving containers B, each container B having a container opening B1 with an opening edge B2, a container wall B3 and a container bottom B4, has a first section 20, which is mounted rotatably at or in the container receptacle 100, a second section 30 which is rotatably supported about a longitudinal axis A of the first section 20, a sealing surface 52 which is provided for sealing the container opening B1 of a container B inserted into the container receptacle 100, and a pressure line 60 going through the first section 20 and the second section 30 and emerging through the sealing surface 52, whereas the second section 30 is rotatably supported about the pressure line 60. The second section 30 rotatably mounted on the first section 20 is mounted to move along the longitudinal axis A with respect to the first section 20 by a lift degree Z, whereas the second section 30 actuates a valve 70 via by a valve actuator 80, a valve which is coupled to a valve actuator 80.

### LIST OF REFERENCE NUMERALS

A Longitudinal axis
a Rotational axis
AB Axis (container)
B Container
B1 Container opening
B2 Opening edge
B3 Container wall
B4 Container base
L Distance
Z Lift amount
10 Holder
13 Receiving chamber
14 Through-opening
15 Inner thread
20 First section
21 Shank
22 Housing
23 Lid
24 Shank
25 Outer circumference
26 End
27 Attachment
271 Shank
272 Head
274 Through-opening
28 Outer circumference
30 Second section
31 Housing
32 Front side
33 First receptacle
36 Second receptacle
37 Base
38 Front face
39 Slide ring
50 Sealing element
51 Forward side
52 Sealing face
54 Through-opening
57 Rear side
60 Pressure line
61 Through-bore
62 Inner thread
63 Inner thread
64 Tubular piece
65 Tubular section
66 Discharge opening
70 Valve
71 Valve element
72 Valve housing
73 Spring-loaded element
80 Valve trigger
81 Stylus
82 Recess
83 First end
85 Second end
90 Ball bearing
91 Ring
92 Ball
94 Circumferential surface/running surface
95 Central section
96 First side section
97 Second side section
100 Container receptacle
101 Receptacle
110 Holder
120 Clamping means

1. A holder (10) for a container receptacle (100) which is provided for receiving containers (B), wherein each container (B) has a container opening (B1) with an opening rim (B2), a container wall (B3) and a container base (B4),
a) has a first section (20) which is non-rotatably mounted on or in the container receptacle (100),
b) a second section (30) which is mounted on the first section (20) so as to be rotatable about a longitudinal axis (A), and a sealing surface (52) which is provided to seal the container opening (B1) of a container (B) inserted into the container receptacle (100), and
c) and a pressure line (60) which passes through the first section (20) and the second section (30) and opens out through the sealing surface (52).

2. A holder according to claim 1, characterised in that the second section (30) is rotatably mounted around the pressure line (60).

3. A holder according to claim 1 or 2, characterised in that the sealing surface (52) of the second section (30) is formed on one end face (32) of the second section (30) facing away from said first section (20).

4. A holder according to claim 3, characterised in that the sealing surface (52) is concave, relative to the end face (32) of the second section (30).

5. A holder according to any of the claims 1 to 4, characterised in that the sealing surface (52) is formed on a sealing element (50) which is detachably inserted into the second section (30).

6. A holder according to any of the claims 1 to 5, characterised in that the second section (30) is mounted rotatably at the first section (20) along the longitudinal axis (A) relative to the first section (20) which can be displaced by a lift degree (Z).

7. A holder according to any of the claims 1 to 6, characterised in that a ball bearing (90) is provided between the first section (20) and the second section (30).

8. The holder according to claim 7, characterised in that the first section is provided with a shank (24) at its end facing the second section (30), whereas a running surface (94) for the balls (92) of the ball bearing (90) is provided on the outer circumference (25) of the shank (24) at least in sections.

9. The holder according to claim 8, characterised in that the shank (24) carries an attachment (27) at its end (26) facing said second section (30), which continues with its outer circumference (28) the shank (24) and the running surface (94).

10. The holder according to claim 8 or 9, characterised in that the running surface (94) is concave radially to the longitudinal axis (A), with a cylindrical central section (95), a first side section (96) facing said first section (20) and a second side section (97) facing said second section (30).

11. The holder according to claim 10, characterised in that the side sections (96, 97) of the running surface (95) are inclined in opposite directions with an oblique angle with respect to an angle to the longitudinal axis (A).

12. A holder according to any of the claims 1 to 11, characterised in that a valve (70) is arranged in the pressure line (60) which is coupled to a valve actuator (80).

13. The holder according to claim 12, characterised in that the valve actuator (80) is operable from the second section (30) mounted longitudinally displaceably mounted on the first section (20).

14. The holder according to claim 12 or 13, characterised in that the valve (70) and the pressure line (60) form a preassembled construction unit.

15. A container receptacle (100) for receiving containers (B), wherein each container (B) has a container opening (B1) with an opening rim (B2), a container wall (B3) and a container base (B4),
a) a holder (110) for supporting the container base (B4) of a container (B) inserted into the container receptacle (100),
b) wherein the holder (110) is rotatably supported about a longitudinal axis (A) and
c) with a holder (10) according to one of the claims 1 to 14,
d) whereas the first section (20) of the holder (10) is non-rotatably mounted on or in the container receptacle (100),
e) wherein the second section (30) of the holder (10) is rotatably mounted on the first section (20) about the longitudinal axis (A), and
f) wherein the distance (L) is variable between the holder (110) and the holder (10) by a tensioning means (120).
